(19) United States
(12) Patent Application Publication
(10) Pub. No.: US 2013/0070134 A1
(43) Pub. Date: Mar. 21, 2013

(54) Low Noise CMOS Pixel Array

(71) Applicants: Boyd Fowler, Sunnyvale, CA (US); Xingzao Liu, Mountain View, CA (US)

(72) Inventors: Boyd Fowler, Sunnyvale, CA (US); Xingzao Liu, Mountain View, CA (US)

(21) Appl. No.: 13/235,311

(22) Filed: Sep. 16, 2011

(51) Int. Cl. H04N 5/335

(52) U.S. Cl. 348/300; 348/E05.091

(57) ABSTRACT

An imaging array having a plurality of pixels is disclosed. Each pixel includes a photodetector that converts light to charge, a floating diffusion node, a first amplification stage connected to the floating diffusion node, and a select gate that connects the pixel to a second amplification stage. The first and second amplification stages form a current mirror. The first amplification stage includes a buried channel device. In one aspect of the present invention, the current minor has an overall voltage gain of between 0.9 and 1.1. In another aspect of the invention, the second amplification stage is shared by a plurality of pixels.

### BACKGROUND OF THE INVENTION

CMOS image sensors based on an active pixel design have gained wide acceptance in camera applications. In such sensors each pixel includes a photoreceptor that accumulates charge during an exposure. The accumulated charge is converted to a voltage by an output amplifier that is typically constructed from a source follower transistor that receives the charge at its gate and drives a bit line that is connected to the readout circuitry in the imaging array. The cost of the sensor is a direct function of the area of silicon needed for each pixel. To reduce the cost, pixel sizes have been reduced. However, the minimum size of the pixel depends on the charge-to-voltage conversion in the pixel and the noise levels in the pixel. Hence, pixels with high charge-to-voltage conversion factors and low noise are desired.

The capacitance of the output stage determines the charge-to-voltage conversion ratio. Hence, arrangements that reduce this capacitance without significantly increasing the size of the imaging array are desirable. The capacitance at the output stage is determined by two “capacitors”. The first is the parasitic capacitance of the floating diffusion node on which the photo-generated charge is deposited, and the second is the capacitance between the gate and drain of the source follower. To reduce the second capacitance, the gain of the source follower must be as close to one as possible, since this capacitance is typically proportional to (1-A), where A is the gain of the source follower stage.

The source follower also contributes to the noise introduced in the image. As the pixel size is reduced, the noise introduced by the source follower becomes significant. Hence, pixel designs that provide lower noise for this driving stage without increasing the area of the driving amplifier are desired.

### SUMMARY OF THE INVENTION

The present invention includes an imaging array having a plurality of pixels. Each pixel includes a photodetector that converts light to charge, a floating diffusion node, a first amplification stage connected to the floating diffusion node, and a select gate that connects the pixel to a second amplification stage. The first and second amplification stages form a current mirror. The first amplification stage includes a buried channel device. In one aspect of the present invention, the current minor has an overall voltage gain of between 0.9 and 1.1. In another aspect of the invention, the second amplification stage is shared by a plurality of pixels.

### BRIEF DESCRIPTION OF THE DRAWINGS

FIG. 1 is a block diagram of a prior art CMOS imaging array.

FIG. 2 is a schematic drawing of a typical prior art pixel cell.

FIG. 3 illustrates a portion of an imaging array according to one embodiment of the present invention.

FIG. 4 illustrates another embodiment of a pixel array according to the present invention.

### DETAILED DESCRIPTION OF THE PREFERRED EMBODIMENTS OF THE INVENTION

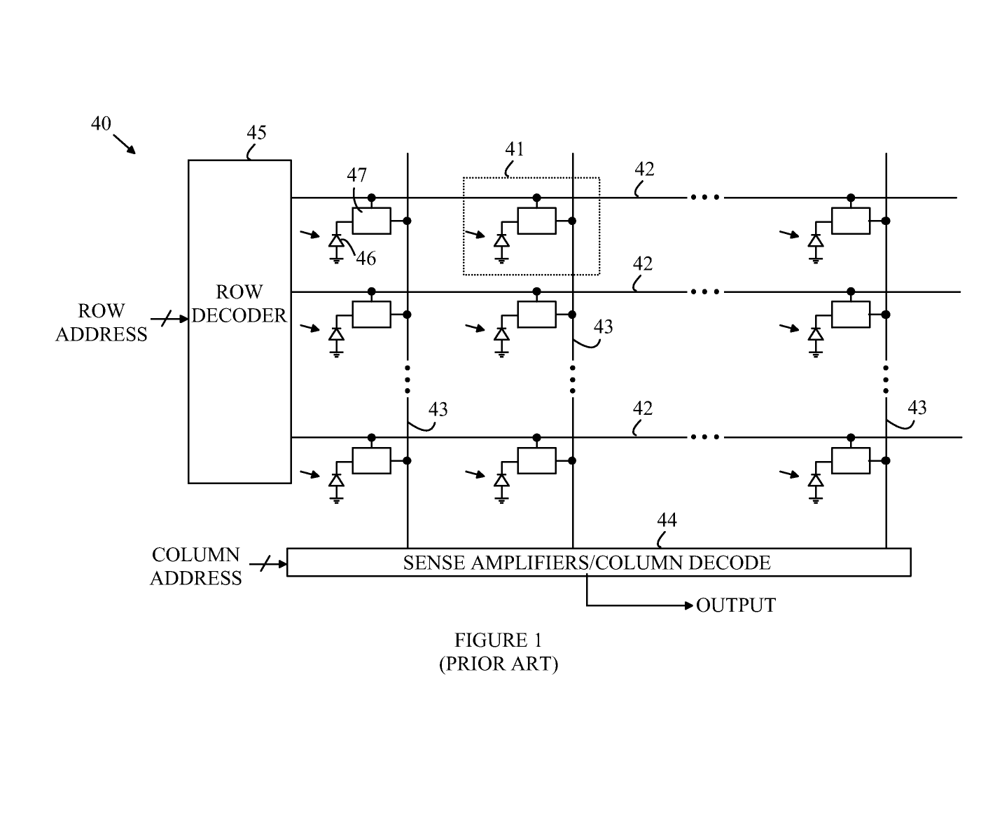

The manner in which the present invention provides its advantages can be more easily understood with reference to FIG. 1, which is a block diagram of a prior art CMOS imaging array. Imaging array 40 is constructed from a rectangular array of pixel cells 41. Each pixel cell includes a photodiode 46 and an interface circuit 47. The details of the interface circuit depend on the particular pixel design. However, all of the pixel circuits include a gate that is connected to a row line 42 that is used to connect that pixel to a bit line 43. The specific row that is enabled at any time is determined by a bit address that is input to a row decoder 45.

The various bit lines terminate in a column processing circuit 44 that typically includes sense amplifiers and column decoders. Each sense amplifier reads the signal produced by the pixel that is currently connected to the bit line processed by that sense amplifier. The sense amplifiers may generate a digital output signal by utilizing an analog-to-digital converter (ADC). At any given time, a single pixel cell is readout. The specific column that is readout is determined by a column address that is utilized by a column decoder to connect the sense amplifier/ADC output from that column to circuitry that is external to the imaging array.

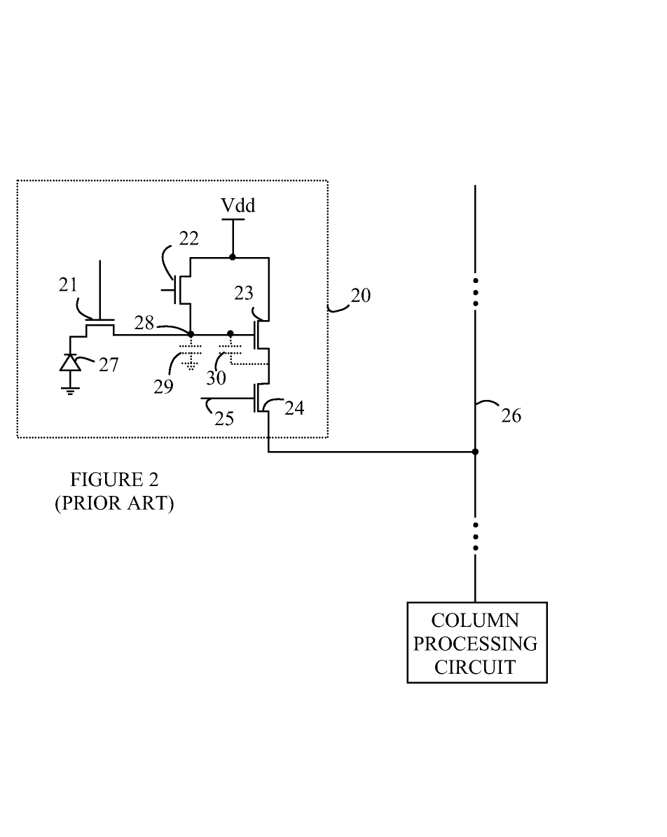

Refer now to FIG. 2, which is a schematic drawing of a typical prior art pixel cell. Pixel cell 20 includes a pinned photodiode 27 that is coupled to a floating diffusion node 28 by gate 21. During the exposure of the imaging array to the image being recorded, charge accumulates in photodiode 27. The accumulated charge is transferred to node 28 by applying a signal to gate 21. The charge transferred to node 28 is converted to voltage by the parasitic capacitor 29 and capacitor 30 associated with the gate of transistor 23, which is connected as a source follower. Transistor 23 provides the gain needed to drive bit line 26 when pixel cell 20 is connected to that bit line via a signal on row select line 25 that is coupled to the gate of transistor 24. Prior to transferring charge from photodiode 27 to node 28, the potential on gate 21 is reset to a predetermined potential via transistor 22. However, there are small variations in the final charge on node 28 after the reset.

A procedure known as correlated double sampling is used to compensate for these variations. The potential on node 28 is then measured by connecting pixel cell 20 to bit line 26. After this starting potential is measured, the charge that accumulated on photodiode 27 is transferred to node 28 and the potential on node 28 is again measured by connecting pixel cell 20 to bit line 26. The difference in the signal between the two potential measurements is the light intensity value that is reported for pixel 20.

The source follower arrangement has two drawbacks. First, the level of 1/f noise associated with the source follower is significant. As the size of the pixels is reduced, this noise presents significant problems. Second, the capacitance of capacitor 30 is approximately proportional to (1-A), where A is the gain of the source follower stage. Hence, if A is reduced to a value that is significantly less than one, the capacitance increases significantly. Since the charge-to-voltage conversion ratio is inversely proportional to this capacitance, the charge-to-voltage gain of the pixel decreases with increasing capacitance. Similarly, if the gain of the amplifier is significantly les than 1, an increase in capacitance occurs.

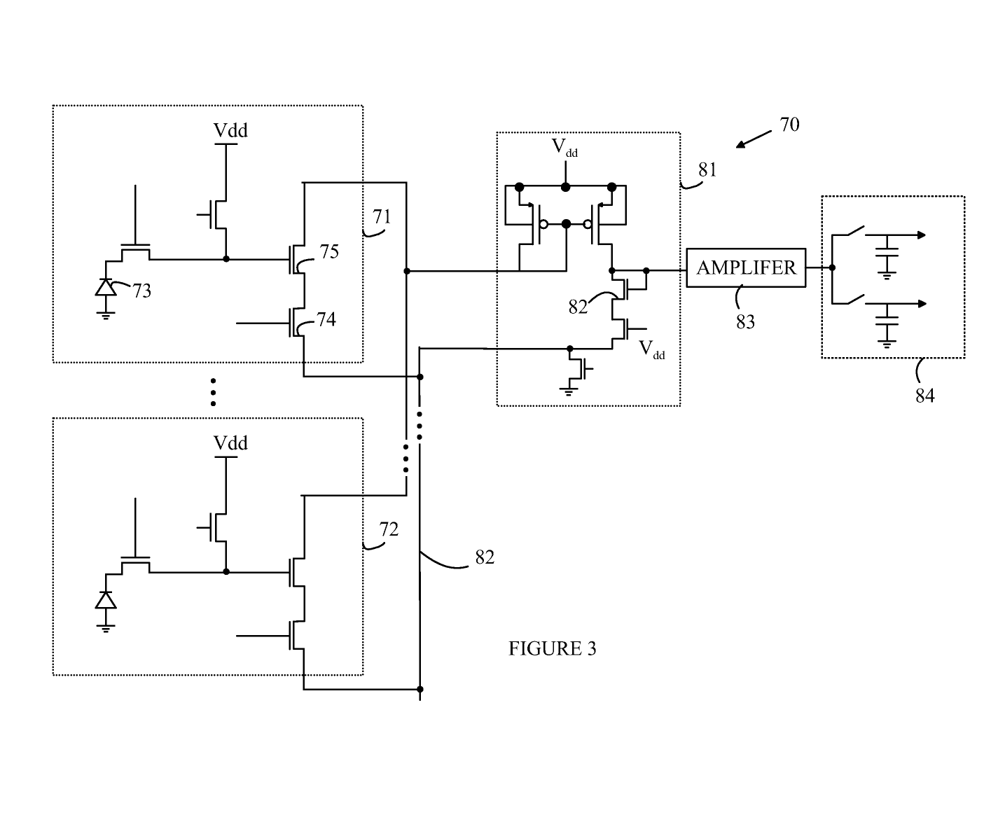

Refer now to FIG. 3, which illustrates a portion of an imaging array according to one embodiment of the present invention. The portion shown in FIG. 3 is a portion of one column of imaging array 70 and includes representative pixel detectors 71 and 72 and a column processing amplifier stage 81. Each pixel includes a photodiode 73 and a gain transistor 75 having a floating diffusion node connected to the base of that gain transistor. Each pixel also includes a select transistor 74. Gain transistor 75 is a buried channel device connected as a source follower. For the purposes of this discussion, a buried channel device is defined to be a transistor having a layer of semiconductor of a first type over a channel region of the opposite semiconductor type, such that carriers flow through the channel under the layer of the first conductivity type. In contrast, a surface channel device has its channel under the gate oxide and charge carriers move in a layer adjacent to the top surface of the channel at the interface between the gate oxide and the semiconductor material of the channel. This surface tends to have charge traps that cause the 1/f noise discussed above. By moving the conduction path away from this interface, the carriers avoid these charge traps. Since the channel is farther from the gate electrode, the fields generated in the channel are reduced compared to a surface channel device, and hence, the gain of the device is significantly less than that of a surface channel device.

In one aspect of the present invention, the ratio of the transistor sizes in the current mirror is set such that the gain of the current mirror is between 0.9 and 1.1. As noted above, this reduces the capacitance between the gate and the drain of the driving transistor in the pixel.

When the selected pixel is connected to line 82, the combination of the gain transistor and column processing amplifier stage 81 is a current mirror with the gain transistor in one arm of the current minor. The transistor sizes are chosen such that the gain of the current mirror is as close to 1 as possible. A second buried channel device 82 is connected in the other arm of the current mirror. The output of the current minor stage is amplified in a column amplifier 83 which provides the additional gain needed to bring the signals to levels consistent with the analog-to-digital converters used to digitize the pixel values. In this embodiment, a correlated double sampling circuit 84 is utilized to reduce any reset noise.

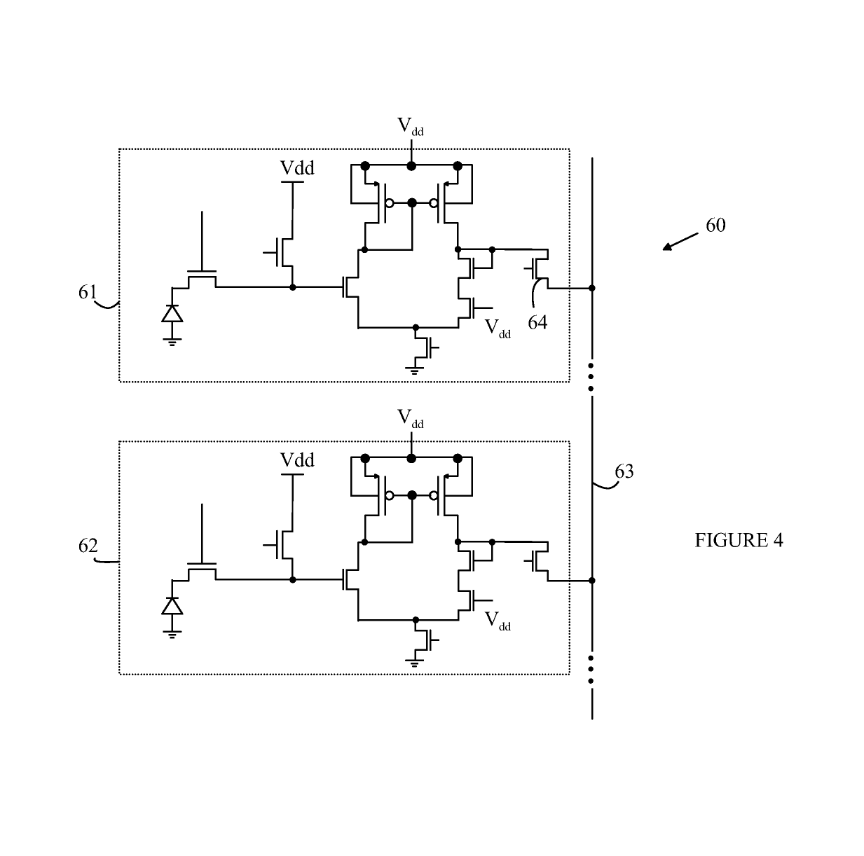

The above-described embodiments of the present invention utilize an imaging array in which the pixels are organized into a rectangular array of pixels having a plurality of rows and columns. In this arrangement, each pixel has half of a current minor driving stage and the column processing circuitry for each column has the other half of the current minor driving stage. However, other arrangements could be utilized. Refer now to FIG. 4, which illustrates another embodiment of a pixel array according to the present invention. Pixel array 60 differs from pixel array 40 discussed above in that a current mirror driving stage is included in each pixel. Exemplary pixels are shown at 61 and 62. The output of the current minor stage is coupled to a bit line 63 via a select transistor 64 included in each pixel. While this arrangement increases the size of each pixel, the extent of the loss of fill factor depends on the ratio of the transistor sizes to the size of the photodiode. The size of the photodiode is set by the amount of light that is available for each pixel in the application utilizing the imaging array, and hence, does not change significantly as fabrication processes move to smaller and smaller feature sizes. The sizes of the transistors, in contrast, continually evolve to smaller and smaller sizes. Hence, the loss of fill factor may eventually be acceptable either at today's feature sizes for some applications or in the near future as transistor sizes decrease further.

The above-described embodiments of the present invention have been provided to illustrate various aspects of the invention. However, it is to be understood that different aspects of the present invention that are shown in different specific embodiments can be combined to provide other embodiments of the present invention. In addition, various modifications to the present invention will become apparent from the foregoing description and accompanying drawings. Accordingly, the present invention is to be limited solely by the scope of the following claims.

1. An imaging array comprising a plurality of pixels,
each pixel comprising a photodetector and a floating diffusion node, and a first amplification stage connected to said floating diffusion node and a select gate that connects said pixel to a second amplification stage, wherein said first and second amplification stages form a current mirror having an overall voltage gain between 0.9 and 1.1 and said first amplification stage comprises a buried channel device.

2. The imaging array of claim 1 wherein said second amplification stage is shared by a plurality of said pixels.

3. (canceled)

4. The imaging array of claim 1 wherein each pixel further comprises a transfer gate that selectively connects said photodetector to said floating diffusion node.

5. The imaging array of claim 1 wherein each pixel further comprises a reset gate that selectively connects said floating diffusion node to a reset power source.

6. The imaging array of claim 1 wherein said pixels are configured as an array of rows and columns of pixels, each column having a first conductor to which said first amplification stage is connected and a second conductor to which said select gate is connected, said second amplification stage being connected to said first and second conductors
